(19) United States
(12) Patent Application Publication
(10) Pub. No.: US 2008/0208958 A1
(43) Pub. Date: Aug. 28, 2008

(54) RISK ASSESSMENT PROGRAM FOR A DIRECTORY SERVICE

(75) Inventors: Patrick C. Huff, San Francisco, CA (US); Kip Michael Gumenberg, Glendale, AZ (US); Hugh Edward Wade, Kenmore, WA (US); John Allen, Kirkland, WA (US); Roger Longden, Houston, TX (US)

Correspondence Address: SENNIGER POWERS LLP (MSFT), ONE METROPOLITAN SQUARE, 16TH FLOOR, ST. LOUIS, MO, 63102, US

(73) Assignee: MICROSOFT CORPORATION, Redmond, MO (US)

(21) Appl. No.: 11/680,405

(22) Filed: Feb. 28, 2007

(51) Int. Cl. G06F 15/16

(52) U.S. Cl. 709/203

(57) ABSTRACT

Testing and evaluating a directory service of a distributed computing environment. Information related to the directory service is collected and a ruleset is executed to identify one or more problem issues as a function of the collected information. The identified problem issue includes a corresponding solution that may be applied to the directory service. A report representative of the identified problem issue and corresponding solution is generated and provided to a directory service administrator or a service engineer.

### BACKGROUND

A key component of a distributed computing environment is a directory service. The directory service acts as a repository of information enabling applications to find, use, and manage the distributed computing environment resources (i.e., user names, network printer, and permissions). Distributed computing environments are usually heterogeneous collections of networks, each with a specific proprietary service to manage its resources. Generally, the directory service provides applications with a set of interfaces designed to eliminate the differences among the heterogeneous networks of the distributed computing environment.

Because the directory service provides information related to all network resources within the distributed computing environment, the larger the distributed computing environment, the more complex the directory server configuration. Additionally, a poorly functioning directory service environment impacts security boundaries, replication, delegate administration, and the like, which causes significant impact to the distributed computing environment. Also, the larger the distributed computing environment, the more users and applications rely on an efficient and correct directory service. However, because of the complexity of such large distributed computing environment, it can be difficult and time consuming to identify configuration and performance issues. Moreover, once an issue is identified, it is critical that a correct solution is applied to the issue as not to impact the overall configuration and performance of the directory service. Ideally, it is best to identify and resolve problems in a proactive manner before an outage or critical situation impacts the directory service and, in turn, the distributed computing environment.

### SUMMARY

Embodiments of the invention overcome one or more disadvantages of an improperly configured directory service by testing and evaluating the directory service of a distributed computing environment. Aspects of the invention include collecting information related to the directory service and executing a ruleset to automatically identify one or more problem issues as a function of the collected information. The identified problem issue includes a corresponding solution that may be applied to the directory service to resolve the identified problem issue. A report representative of the identified problem and solution is generated and provided to a directory service administrator, service engineer, or the like for applying the solution to resolve the identified problem issue.

Aspects of the invention also include allowing a person with expertise with a particular implementation of the directory service to annotate the report for that particular directory service and providing feedback regarding the problem and/or its solution to refine the ruleset. As such, aspects of the invention allow proactive resolution of problem issues that have a potential negative impact on the directory service.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Other features will be in part apparent and in part pointed out hereinafter.

### BRIEF DESCRIPTION OF THE DRAWINGS

FIG. 1 is a block diagram illustrating one example of a suitable distributed computing system environment in which aspects of the invention may be implemented.

FIG. 2 is an exemplary block diagram illustrating a system for analyzing a directory service.

FIG. 3 is an exemplary flow diagram for evaluating and analyzing a directory service.

FIG. 4 is a block diagram illustrating an exemplary computer readable medium on which aspects of the invention may be stored.

Corresponding reference characters indicate corresponding parts throughout the drawings.

### DETAILED DESCRIPTION

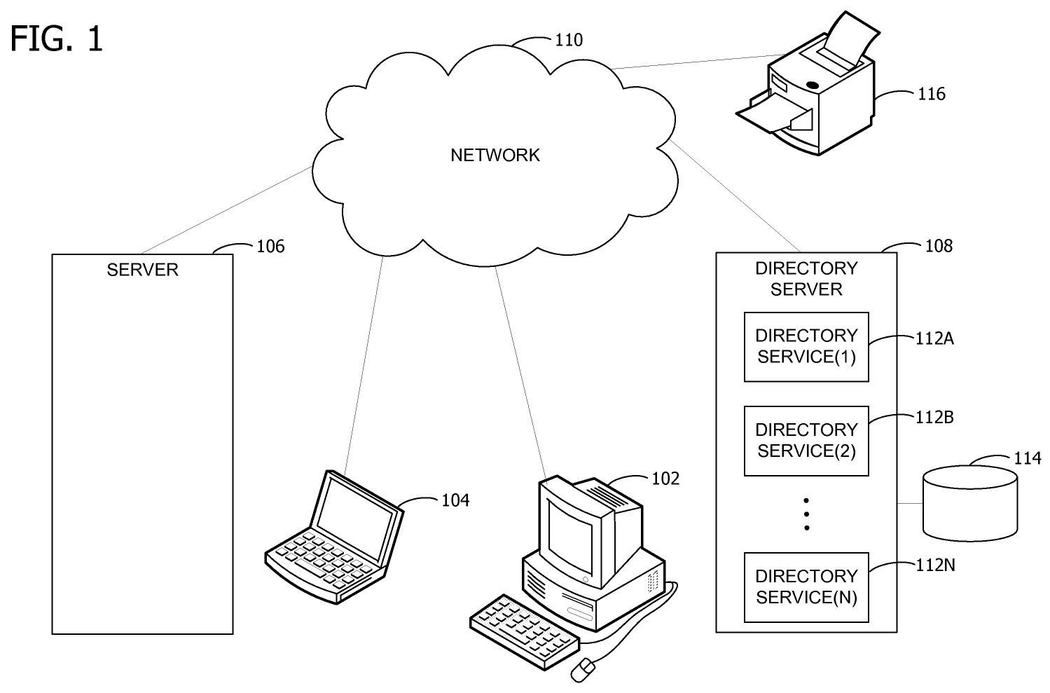

Referring now to the drawings, FIG. 1 is a block diagram illustrating one example of a suitable distributed computing system environment in which aspects of the invention may be implemented. A plurality of computing devices, such as clients (e.g., computer 102 and laptop 104) and servers (e.g., server 106 and directory server 108) are coupled via a network 110. These computing devices access one or more directory services 112 of the directory server 108 through the network 110. In an embodiment, network 110 includes one or more heterogeneous networks. The clients (e.g., computer 102 and laptop 104), servers (e.g., server 106 and directory server 108), and other network resources (e.g., printer 116) may operate in a networked environment using logical connections. The exemplary logical connections depicted in FIG. 1 include a local area network (LAN) and a wide area network (WAN), but may also include other networks. The LAN and/or WAN may be wired networks, wireless networks, a combination thereof, and so on. Such networking environments are commonplace in offices, enterprise-wide computer networks, intranets, and global computer networks (e.g., the Internet). The network connections shown are exemplary and other means of establishing a communications link between the computing devices and other network resources may be used.

The directory server 108 acts as repository of information that enables an application to find, use, and manage the distributed computing environment resources. Such information may include user names, network printer identifiers, permissions, and the like. In an embodiment, directory server 108 stores information regarding the network resources in a database 114 and the directory services 112 have access to the database 114. Alternately, the directory server 108 may comprise one or more master servers which include a local copy of the database 114 containing information associated with the network users and resources.

The directory services 112 (indicated in FIG. 1 at 112A to 112N) include services related to at least one of the following: Domain Name Service (DNS), directory service replication, connectivity of directory service servers, subnet information, group policy information, internet address information, operating system information of directory service servers, access control list configuration, user accounts, machine accounts, account lockouts. For purposes of illustration, programs and other executable program components, such as directory services 112, are illustrated herein as discrete blocks. It is recognized, however, that such programs and components reside at various times in different storage components of the computer, and are executed by the data processor(s) of the computer.

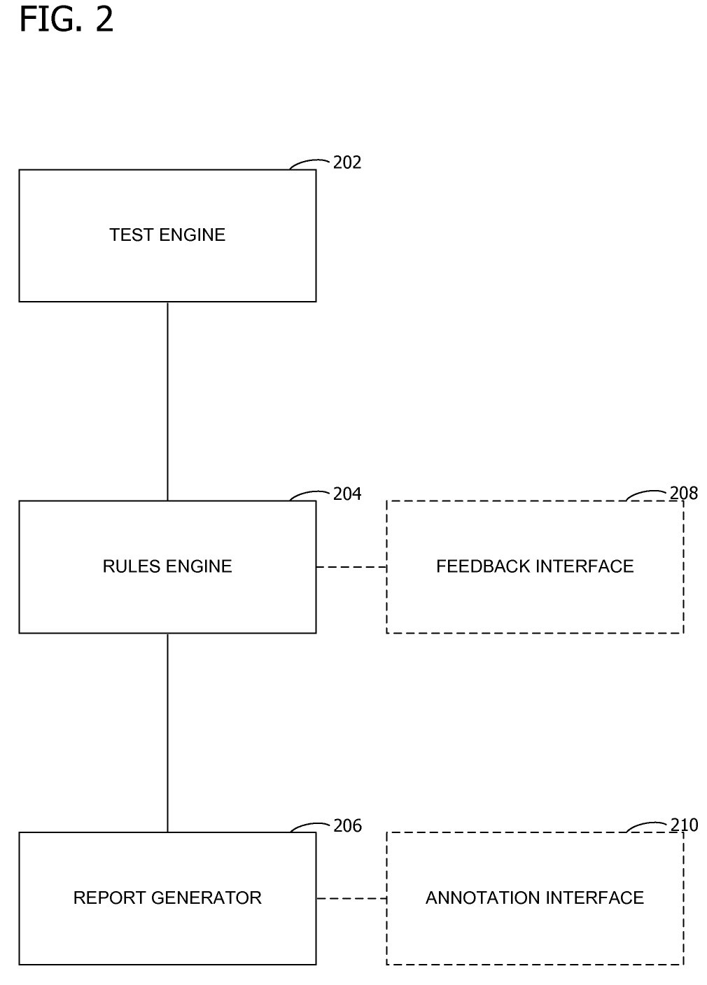

Referring now to FIG. 2, a block diagram for an embodiment of a system for analyzing a directory service is shown. A directory service test engine 202 executes one or more tests to collect data associated with the directory service. For example, the directory service test engine 202 provides real-time information about the performance, configuration, and health of the directory service components (e.g., directory services 112). In an embodiment, the directory service test engine 202 is a multi-threaded application where the tests may be run individually or concurrently in whatever order desired. The tests include collecting information relating to Domain Name Service (DNS), directory service replication, connectivity of directory service servers, subnet information, group policy information, internet address information, operating system information of directory service servers, access control list configuration, user accounts, machine accounts, and account lockouts. APPENDIX A contains an exemplary list of tests performed and their descriptions for an embodiment of the invention.

A rules engine 204 identifies any problem issues of the directory service as a function of the data collected by the directory service test engine 202. In an embodiment, the problem issues include one or more of the following: an error condition and a best practice enhancement of the directory service. Alternatively or additionally, the rules engine 204 includes one or more predefined solutions corresponding to each problem issue. In a third alternative, the rules engine 204 identifies a best practice enhancement of the directory service and includes one or more implementation plans corresponding to each identified best practice enhancement. Advantageously, implementing a plan corresponding to a best practice enhancement aids in optimizing productivity of the distributed computing environment.

A report engine 206 generates a report representative of the problem issues identified by the rules engine 204. Alternatively, the report engine 206 includes a Web-based user interface, where the report data is organized into sections relative to the analyzed directory service component. The user interface incorporates output sorting and filtering capabilities, along with data history for future review.

In an embodiment, the rules engine 204 assesses a risk associated with each identified error condition and report includes the assessed risk for each identified error condition. Advantageously, the report engine 206 exposes problem issues in the directory service infrastructure and operational processes relatively early and, thus, limiting their impact on the distributing computing environment. Thus, by proactively addressing the problem issues, improved uptime results and support costs of the distributing computing environment are lowered.

In an alternative embodiment, the report can be generated and provided to a service engineer. The service engineer can study the report before making a service call, resulting in lower cost and more time efficient service. In another alternative embodiment, a feedback interface 208 modifies the ruleset when the solution is applied to the directory service. In this case, the administrator of the directory service, the service engineer, or another qualified person provides feedback regarding the defined problem condition and/or its corresponding solution and the ruleset is modified as a function of the provided feedback. For example, if the directory service administrator or the service engineer observes an undesired side-effect associated with the solution when it is applied a particular configuration of the directory service, he or she can provide feedback through the feedback interface and the ruleset will be modified to eliminate the undesired side-effect for this particular configuration.

In yet another alternative, an annotation interface 210 allows the service engineer or directory service administrator to modify the solutions and best practices included in the report with expertise specific to the directory service of the distributed computing environment. For example, a particular directory service implementation may have special requirements due to business or technical needs. In this case, an identified problem issue may not be correctly represented in the report and the service engineer or directory service administrator may annotate the report to correctly represent the requirements of this particular implementation. Annotating may include modifications, additions, and deletions to the report.

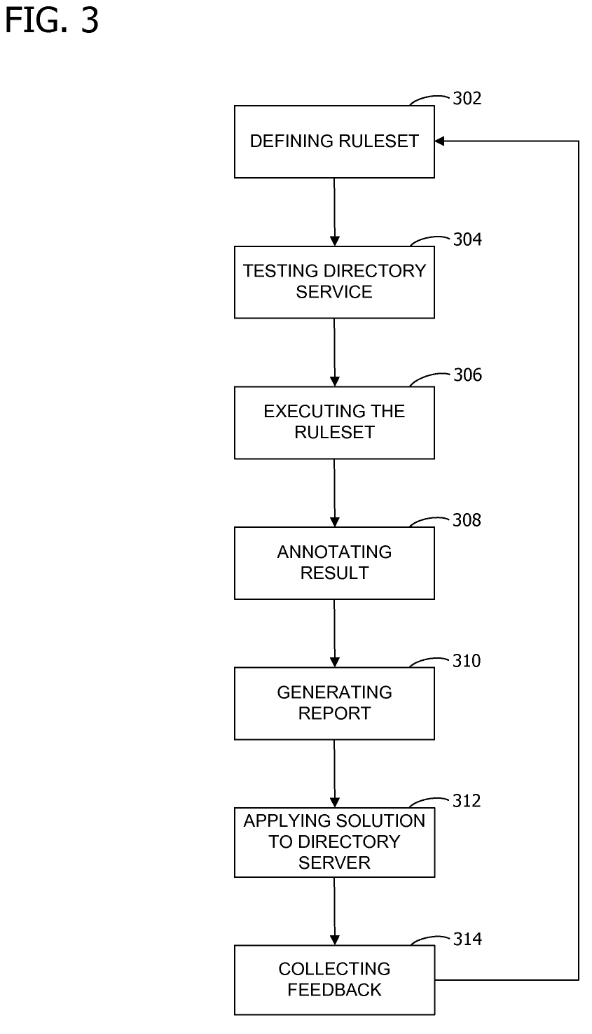

FIG. 3 is a flow diagram for a method of evaluating a directory service. At 302, a ruleset is defined. The ruleset identifies problem issues with the directory service. At 304, a one or more tests are performed on the directory service to collect data associated with a configuration of the directory service. The tests examine the health of the operational components of directory service. For example, the directory service is evaluated for errors, single points of failure and proper configuration. APPENDIX A contains a list of tests implemented in an embodiment. Additional configuration information may be collected by surveying an administrator of the directory service.

At 306, the ruleset is executed against the collected data. If at least one problem issue with the directory service exists, executing the ruleset according to aspects of the invention identifies the problem issue and a corresponding solution. For example, problem issues may include “Master Server Did Not Replicate Within Time-out Period”, “Group Members Count 5,000 or Greater”, “Inbound Replication Disabled”, and “List of Missing Subnets”. Alternatively or additionally, the ruleset is executed against the collected data to compare the directory service architecture against known best practices. A best practice is known implementation that allows multiple organizations to perform similar tasks in a reliable and efficient manner. In this case, the experience of service engineers and directory service administrators are used to develop best practices that allow the directory service to operate in a reliable and efficient manner. Thus, a problem issue may be defined as non-conformance with a best practice and the corresponding solution may be a plan for implementing the best practice (i.e., a best practice enhancement).

At 308, the problem issue and/or its corresponding solution are annotated with expertise specific to the directory service of the distributed computing environment. At 310, a report representative of the annotated result is generated. In an embodiment, report is includes details regarding any findings of a service engineer. This includes work that was performed and remediated at a customer site and outstanding issues that need further attention.

At 312, the corresponding solution is applying to the directory service to resolve the identified problem issue. In an embodiment, the problem issue is associated with a priority rank and the solution is applied to the directory service in order of priority rank. For example, priority ranks may include Critical, Error, Warning, and Informational, where Critical has the highest priority and Informational has the lowest priority. Advantageously, when solutions are applied in order of priority rank, problem issues having the potential for the most serious negative impact to the directory service are applied first. At 314, feedback related to the identified problem issue and its corresponding solution collected. In an embodiment the feedback is collected from one or more of the following: an administrator of the directory service and the execution of one or more tests on the directory service. And, at 302, the ruleset is refined as a function of the collected feedback.

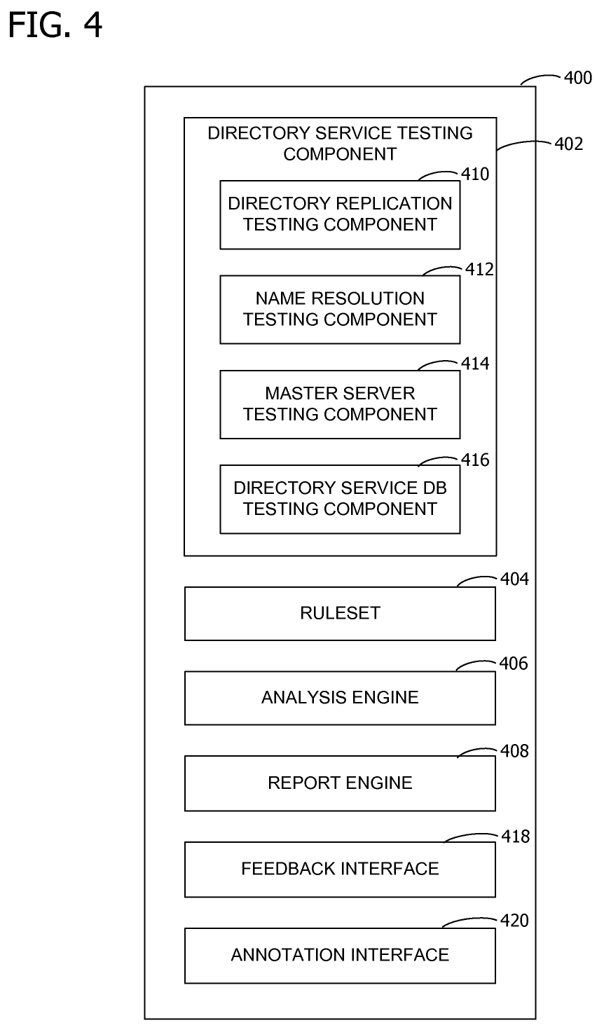

FIG. 4 is a block diagram illustrating an exemplary computer readable media on which aspects of the invention may be stored. The computer readable media 400 includes computer-executable components for analyzing directory service components within a distributed computing environment. In an embodiment, the computer readable media 400 includes a directory service testing component 402, a ruleset 404, an analysis engine 406 and a report engine 108.

The client computers (e.g., computer 102 and laptop 104) and servers (e.g., server 106 and directory server 108) have at least some form of computer readable media. Computer readable media, which include both volatile and nonvolatile media, removable and non-removable media, may be any available medium that may be accessed by such computing devices. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by clients (e.g., computer 102 and laptop 104) and servers (e.g., server 106 and directory server 108).

Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media.

In the exemplary embodiment of FIG. 4, the directory service testing component 402 includes one or more testing components for collecting data related to a plurality of directory service components. In one embodiment, the testing components include one or more of the following: a directory replication testing component 410 for collecting data related to a directory service replication; a name resolution testing component 412 for collecting data related to a resolution service; a master server testing component 414 for collecting data related to a master server; and a directory service database testing component 416 for collecting data related to a directory service database (e.g., database 114). Alternatively, the testing components may also include one or more of the following: a file replication testing component for collecting data related to file replication services; a backup and recovery testing component for collecting data related to system backup and recovery; and an account testing component for collecting data related to account services.

The ruleset 404 defines one or more problem issues of the directory service as a function of the collected data. In an alternative embodiment, the ruleset also includes a predefined solution for each problem issue. Furthermore, the ruleset may also include a priority indicator for each rule of the ruleset. In yet another embodiment, the ruleset includes defines best practice enhancement and a corresponding implementation plan for each defined best practice enhancement.

The analysis engine 406 executes the ruleset against the collected data to identify at least one problem issue of the directory service. And, a report engine 408 produces a representation of the at least one problem issue of directory service identified by the analysis engine 406. APPENDIX B contains excerpts from a exemplary report generated according to an embodiment of the invention.

In an alternative embodiment, the computer readable media includes a feedback interface 418. The feedback interface 418 collects feedback information related to the solution specified by the analysis engine when the solution is applied to the directory service. Furthermore, the feedback interface 418 updates the ruleset as a function of the collected feedback information.

The computer readable media 400 may optionally include an annotation interface 420. The annotation interface 420 receives input from an expert familiar with the directory service and modifies the problem issue, the solution, or both, as a function of the input.

Embodiments of the invention may be described in the general context of computer-executable instructions, such as program modules, executed by one or more computers or other devices. Generally, program modules include, but are not limited to, routines, programs, objects, components, and data structures that perform particular tasks or implement particular abstract data types. Aspects of the invention may also be practiced in distributed computing environments where tasks are performed by remote processing devices that are linked through a communications network. In a distributed computing environment, program modules may be located in both local and remote computer storage media including memory storage devices.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Embodiments of the invention may be implemented with computer-executable instructions. The computer-executable instructions may be organized into one or more computer-executable components or modules. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

### APPENDIX A

Below is an exemplary list of the tests available within a test engine embodying aspects of the invention. The tests can be run individually or concurrently in whatever order desired.

Prerequisites:

| Test Name | Description | Data Collection |
|---|---|---|
| Directory | The test queries all master servers | Contacts every |
| Service | in the distributed computing | master server in the |
| Depend- | environment to verify if basic | distributed computing |
| encies | connectivity is available. The test | environment |
| | verifies that the master servers can | Primary data |
| | be contacted via ping, LDAP | collection methods: |
| | (Lightweight Directory Access | ping.exe |
| | Protocol, WMI (Windows | portqry.exe |
| | Management Instrumentation), | LDAP |
| | RPC (Remote procedure call), | WMI |
| | Kerberos and other ports. | |

Directory Service Replication:

| Test Name | Description | Data Collection |
|---|---|---|
| Site | The Site Configuration test | Contacts every master server |
| Configuration | queries configuration information | in the distributed computing |
| | on the directory service site | environment |
| | topology. This includes | Primary data collection |
| | information about the bridgehead | methods: |
| | servers, Site Links, replication | LDAP |
| | connection objects, Site options, | WMI |
| | LDAP policies, etc. | |
| Subnet | The Subnet Information test | Contact every master server in |
| Information | queries domain controllers and | the distributed computing |
| | the directory service sites | environment |
| | configuration for missing or old | Primary data collection |
| | subnet definitions, | methods: |
| | | LDAP |
| | | WMI |
| Replication | The Replication Status test | Contacts every master server |
| Status | queries every master server in the | in the distributed computing |
| | distributed computing | environment |
| | environment for any replication | Primary data collection |
| | failures. This includes displaying | methods: |
| | the replication partners for each | repadmin.exe |
| | master server, what the largest | LDAP |
| | replication delta is, etc. | |
| Replication | The Replication Configuration | Contacts every master server |
| Configuration | test queries configuration | in the distributed computing |
| | information from each master | environment |
| | server in the distributed | Primary data collection |
| | computing environment | methods: |
| | regarding certain replication | LDAP |
| | settings and statistics. The | WMI |
| | settings include strict replication | repadmin.exe |
| | consistency, change notification | |
| | intervals, fixed replication ports, | |
| | etc. | |
| Directory Service | The Directory Service | Contacts every master server |
| Convergence | Convergence test determines how | in the distributed computing |
| | long it takes for a change in | environment |
| | directory service to replicate to | Primary data collection |
| | every master server in the | methods: |
| | distributed computing | LDAP |
| | environment. This is used to help | |
| | verify the convergence time | |
| | matches the customer's | |
| | expectations and the intended | |
| | replication topology design. The | |
| | convergence time is a snapshot | |
| | only. It does not necessarily | |
| | indicate the best or worse | |
| | possible time since the value can | |
| | change depending upon when the | |
| | test is run. | |
| | This test works by modifying the | |
| | “description” attribute of the | |
| | Authenticated Users object. This | |
| | object has no description by | |
| | default. Once the attribute is | |
| | modified the script queries each | |
| | master server (serially) in the | |
| | distributed computing | |
| | environment until they all receive | |
| | the change. This is how | |
| | distributed computing | |
| | environment-wide directory | |
| | service replication convergence is | |
| | determined. Once the test ends | |
| | the attribute is reset. If it was | |
| | blank, it goes back to blank. If it | |
| | had a description then that is | |
| | returned. | |
| Large Groups | The Large Groups test queries | Contacts one master server per |
| | each Domain in the distributed | Domain |
| | computing environment for any | Primary data collection |
| | ‘large’ groups that could cause | methods: |
| | replication issues. The test warns | LDAP |
| | of any groups with 4,500–5,000 | repadmin.exe |
| | members and errors if they | |
| | exceed 5,000 members. | |
| Distributed | The distributed computing | Contacts one master server per |
| Computing | environment/Domain | Domain |
| Environment/ | Information test queries certain | Primary data collection |
| Domain Info | configuration information about | methods: |
| | each Domain and the distributed | LDAP |
| | computing environment itself. | |

FRS/SYSVOL/GPOs:

| Test Name | Description | Data Collection |
|---|---|---|
| SYSVOL | The SYSVOL (System Volume) | Contacts every master server |
| Information | Information test queries | in the distributed computing |
| | configuration information and | environment |
| | statistics for the SYSVOL folder | Primary data collection |
| | structure of each master server in | methods: |
| | the distributed computing | LDAP |
| | environment. This includes the | WMI |
| | size of SYSVOL and certain | ntfrsutl.exe |
| | information on its contents. The | |
| | statistics collected help identify | |
| | potential replication issues that | |
| | could cause SYSVOL to become | |
| | out of sync. | |
| FRS | The FRS (File Replication | Contacts every master server |
| Convergence | Service) Convergence test | in the distributed computing |
| | determines how long it takes for a | environment |
| | change in SYSVOL to replicate | Primary data collection |
| | to every master server within | methods: |
| | each Domain. This is used to | RPC calls |
| | help verify the convergence time | |
| | matches the customer's | |
| | expectations and the intended | |
| | replication topology design. The | |
| | convergence time is a snapshot | |
| | only. It does not necessarily | |
| | indicate the best or worse | |
| | possible time since the value can | |
| | change depending upon when the | |
| | test is run. | |
| | This test works by creating a test | |
| | file in SYSVOL and then queries | |
| | each master server in each | |
| | Domain until they all receive it. | |
| | This is how SYSVOL replication | |
| | convergence is determined for | |
| | each Domain. The file is deleted | |
| | at the end of the test. | |
| Orphaned GPTs | The Orphaned GPTs (group | Contacts one master server per |
| | policy templet) test queries the | Domain |
| | group policy template folders of | Primary data collection |
| | each Domain's SYSVOL | methods: |
| | structure, looking for any folders | FindOrphanedGPOsIn |
| | that no longer have | SYSVOL.wsf |
| | corresponding objects in | |
| | directory service. These | |
| | orphaned folders are possible | |
| | when a GPO (group policy | |
| | object) is deleted but something | |
| | is holding open a file/folder in | |
| | SYSVOL. Although orphaned | |
| | GPT folders do no harm they do | |
| | take up disk space and should be | |
| | removed as a cleanup task. | |
| Unlinked | The Unlinked GPOs test queries | Contacts one master server per |
| GPOs | each GPO within each Domain, | Domain |
| | looking for any that are not | Primary data collection |
| | linked anywhere within their own | methods: |
| | Domains. Although there is | FindUnlinkedGPOs.wsf |
| | nothing inherently wrong with | |
| | unlinked GPOs, the intent behind | |
| | this test is to identify any that | |
| | may potentially be old or no | |
| | longer required and therefore can | |
| | be removed as a cleanup task. | |
| GPOTool | The GPOTool test queries the | Contacts one master server |
| | PDCE of each Domain, verifying | per Domain |
| | the objects and files/folders for | Primary data collection |
| | each GPO is in sync from both a | methods: |
| | directory service and SYSVOL | gpotool.exe |
| | perspective. This test can help | |
| | identify GPOs that have objects | |
| | directory service but no | |
| | files/folders in SYSVOL. It can | |
| | also detect version mismatch | |
| | errors between directory service | |
| | and SYSVOL. | |

Name Resolution:

| Test Name | Description | Data Collection |
|---|---|---|
| DNSLint | The DNSLint test queries each | Contacts at least one master |
| | DNS server to verify certain | server and each DNS server |
| | critical records exist and are | distributed computing |
| | correct. The master servers must | environment-wide locator records |
| | be able to properly resolve these | Primary data collection |
| | records in order to replicate, | methods: |
| | | dnslint.exe |
| Diag - DNS | The Diag - DNS (Domain Name | Contacts every master server |
| | Service) test queries each master | in the distributed computing |
| | server in the distributed | environment |
| | computing environment to verify | Primary data collection |
| | certain DNS client and server (if | methods: |
| | applicable) configuration settings. | dcdiag.exe |
| | These settings include verifying | |
| | the master servers are pointing at | |
| | valid DNS servers, forwarder | |
| | configuration are valid, | |
| | delegations are valid, dynamic | |
| | updates are working and certain | |
| | SRV (Service) records are | |
| | properly registered. | |
| DNS | The DNS Information test queries | Contact every master server in |
| Information | each master server in the | the distributed computing |
| | distributed computing | environment |
| | environment to determine if it is a | Primary data collection |
| | DNS server and if so collects | methods: |
| | configuration information about | dnscmd.exe |
| | its server configuration and the | |
| | zones it hosts. | |
| WINS 1B and | The WINS 1B and 1C test queries | Contacts each WINS server |
| 1C | the WINS servers used within the | used by directory service that |
| | directory service infrastructure to | replicates amongst each other. |
| | determine how the WINS servers | Primary data collection |
| | replicate amongst themselves and | methods: |
| | that certain key WINS records | WMI |
| | registered by the master servers | netsh.exe |
| | exist and are accurate. | nblookup.exe |
| IP | The IP Information test queries | Contacts every master server |
| Information | the DNS and IP configuration of | in the distributed computing |
| | each master server in the | environment |
| | distributed computing | Primary data collection |
| | environment. This includes each | methods: |
| | master server's IP address, what | WMI |
| | DNS and WINS servers they | |
| | point to, whether the master | |
| | servers are DNS or WINS | |
| | servers, etc. | |

Master Server Health:

| Test Name | Description | Data Collection |
|---|---|---|
| Diag - General | The Diag - General test queries | Contacts every master server |
| | each master server in the | in the distributed computing |
| | distributed computing | environment |
| | environment against a large series | Primary data collection |
| | of tests. These tests include | methods: |
| | verifying a master server's | dcdiag.exe |
| | computer object is configured | |
| | correctly, critical services are | |
| | running, knowledge of the FSMO | |
| | role holders, etc. The output is | |
| | limited to errors only. | |
| OS Information | The OS Information test queries | Contacts every master server |
| | certain configuration information | in the distributed computing |
| | about every master server in the | environment |
| | distributed computing | Primary data collection |
| | environment. This includes the | methods: |
| | OS version, service pack level, | WMI |
| | uptime, and certain memory | |
| | configuration settings. | |
| Event Logs | The Event Logs test queries for | Contacts every master server |
| | all warning and error events from | in the distributed computing |
| | every master server in the | environment |
| | distributed computing | Primary data collection |
| | environment. It utilizes a | methods: |
| | threshold to determine how far | WMI |
| | back to query. | |
| Security Updates | The Security Updates test queries | Contacts every master server |
| | for missing security updates from | in the distributed computing |
| | every master server in the | environment |
| | distributed computing | Primary data collection |
| | environment. | methods: |
| | | Baseline Security |
| | | Analyzer |
| Time Configuration | The Time Configuration test | Contacts every master server |
| | queries how each master server in | in the distributed computing |
| | the distributed computing | environment |
| | environment is configured to | Primary data collection |
| | synchronize time. This includes | methods: |
| | identify master servers that are | WMI |
| | synchronizing via the Domain | w32tm.exe |
| | hierarchy or if manually | |
| | configured to use specific time | |
| | sources. | |
| Performance | The Performance Counters test | Contacts every master server |
| Counters | queries certain performance | in the distributed computing |
| | statistics for each master server in | environment |
| | the distributed computing | Primary data collection |
| | environment. These statistics | methods: |
| | include overall CPU utilization, | Performance counters |
| | LSASS.EXE CPU and memory | WMI |
| | utilization, open sessions and | |
| | files, total logons, etc. This test | |
| | performs a certain number of | |
| | snapshots over a set period of | |
| | time and then averages the results. | |

Directory Service Database:

| Test Name | Description | Data Collection |
|---|---|---|
| Database Info | The Database Info test queries | Contacts every master server |
| | certain configuration information | in the distributed computing |
| | and statistics about the directory | environment |
| | service database for each master | Primary data collection |
| | server in the distributed | methods: |
| | computing environment. This | WMI |
| | includes the location of the | |
| | directory service database and | |
| | logs, how large the database is, | |
| | how much white space exists in | |
| | the logs, etc. | |
| Partition ACLs | The Partition ACLs (Access | Contacts one master server per |
| | Control List) test queries the | Domain |
| | security access control lists at the | Primary data collection |
| | root of every partition in the | methods: |
| | distributed computing | acldiag.exe |
| | environment. | |
| Directory Service | The Directory Service Object | Contacts one master server |
| Object Count | Count test queries type and | per Domain |
| | number of all objects in the | Primary data collection |
| | Domain partition of each Domain | methods: |
| | in the distributed computing | dsobjsummary.exe |
| | environment. It provides an | |
| | overall object total and a per | |
| | object class total. This can help | |
| | identify potential object classes or | |
| | totals that are either abnormal or | |
| | may indicate the lack of proper | |
| | database maintenance processes. | |

Backup:

| Test Name | Description | Data Collection |
|---|---|---|
| Backup | The Backup Status test queries | Contacts one master server |
| Status | every partition in the distributed | per Domain |
| | computing environment to | Primary data collection |
| | determine when they were last | methods: |
| | backed up. | Repadmin.exe |

Other:

| Test Name | Description | Data Collection |
|---|---|---|
| User Account | The User Account Information | Contacts one master server |
| Info | test queries every user account in | per Domain |
| | each Domain in the distributed | Primary data collection |
| | computing environment, | methods: |
| | identifying accounts that may be | LDAP |
| | stale. Staleness is defined as an | |
| | account that has not changed its | |
| | password within a defined | |
| | threshold. The test also reports | |
| | accounts that have ‘password | |
| | never expires’ set, have never set | |
| | a password, are disabled, etc. It | |
| | also includes how many members | |
| | the high level administrative | |
| | groups have. | |
| Machine | The Machine Account | Contacts one master server per |
| Account Info | Information test queries every | Domain |
| | computer account in each Domain | Primary data collection |
| | in the distributed computing | methods: |
| | environment, identifying accounts | LDAP |
| | that may be stale. Staleness is | |
| | defined as an account that has not | |
| | changed its password within a | |
| | defined threshold. The test also | |
| | reports accounts that have | |
| | ‘password never expires’ set, have | |
| | never set a password, are | |
| | disabled, etc. | |
| Account Lockouts | The Account Lockouts test | Contacts every master server |
| | queries each Domain in the | in the distributed computing |
| | distributed computing | environment |
| | environment for any user | Primary data collection |
| | accounts that are currently locked | methods: |
| | out. This includes when the | LDAP |
| | account was locked out and what | WMI |
| | master server initiated the | |
| | lockout. This can be used to help | |
| | identify potentially suspicious | |
| | lockout behavior and to help | |
| | troubleshoot repeated lockouts. | |

### APPENDIX B

This appendix contains excerpts from an exemplary report generated according to an embodiment of the invention.

Risk Assessment Program for Directory Service

The Risk Assessment Program for Directory Service provides critical insight into the health of your entire Directory Service environment. Capturing a comprehensive set of data through specifically designed diagnostic tools and subsequent joint analysis between experienced engineers and your own key staff enables exposure of key vulnerabilities and formulation of a practical remediation roadmap. This report provides an analysis of the findings and recommendations based on the following categories.

Directory Service Environment Overview Environment

Company A's Directory Service environment consisted of a single Distributed computing environment with a single Domain named Company A.com. The Distributed computing environment was operating at Version 1 of operating system functional level. There were 75 Sites, 42 of which contained at least one Master server. There were 45 Master servers, each running Version 1 of operating system. Company A was in the process of consolidating many external Domains and Distributed computing environments into the Company A.com Distributed computing environment.

Summary of Findings

Overall, Company A's directory service environment appeared to be functioning well. There were some errors, but were caught before impacting the overall environment. There were also design and configuration recommendations, primarily to comply with current best practices. A summary of the findings and recommendations are found below. Further detail is available in subsequent sections that focus on the key areas covered in the health check. A complete set of the tools and collected data was left with the customer. Findings are categorized into the following severities:

| Severity | Description | Risk |
|---|---|---|
| Critical | A critical problem has caused or could | Service availability to a Site, |
| | cause a significant or even irreparable | Domain or Distributed |
| | damage to a master server, Site, Domain | computing environment |
| | or Distributed computing environment. | is/could be impacted. |
| Error | A critical problem has occurred or is | Service availability to a Site |
| | imminent to a master server, Site or | or Domain is/could be |
| | Domain. | impacted. |
| Warning | A problem has occurred or is imminent to | Service availability to a Site |
| | a master server or Site. | or Domain should not be |
| | | impacted. |
| Informational | A minor problem or configuration issue | Service availability is not |
| | that should be reviewed. | impacted. |
| Best Practice | Improving the current state of a master | None |
| | server, Site, Domain or Distributed | |
| | computing environment. | |

The following are exemplary error conditions (i.e., problem issues):

| | | | | Resolved |
|---|---|---|---|---|
| | Severity | Category | Description | Onsite |
| 1 | Error | Directory Service | master servers in Sites Missing | Yes |
| | | Replication | Subnet Definition | |
| 2 | Error | Directory Service | No Global Catalogs in Site | No |
| | | Replication | | |
| 3 | Error | Directory Service | Single Preferred Bridgehead | Yes |
| | | Replication | | |
| 4 | Error | Master Server Health | Diag Errors | Yes |
| 5 | Error | Master Server Health | Master servers are 3 minutes or | Yes |
| | | | more out of sync | |
| 6 | Error | Name Resolution | DNS Server Not Pointing To | No |
| | | | Itself for DNS | |
| 7 | Error | Name Resolution | Domain 1B Registrations are not | No |
| | | | consistent | |
| 8 | Error | Name Resolution | Invalid DNS Address | No |
| 9 | Error | Name Resolution | Missing Domain 1B | No |
| | | | Registration | |
| 10 | Error | Name Resolution | Missing Domain 1C | No |
| | | | Registration | |
| 11 | Error | Name Resolution | Single Valid DNS Address | No |
| 12 | Error | Name Resolution | WINS server could not be | No |
| | | | contacted | |
| 13 | Error | Name Resolution | WINS Split Registration | No |
| 14 | Warning | Directory Service | Extra NTDS Settings Object | No |
| | | Replication | | |
| 15 | Warning | Directory Service | Missing subnets in directory | No |
| | | Replication | service | |
| 16 | Warning | Directory Service | Event ID 1173, DB Exception | No |
| | | Replication | Warning | |
| 17 | Warning | Master Server Health | Antivirus exclusions for | No |
| | | | directory service | |
| 18 | Warning | Master Server Health | LSASS CPU Utilization 25% or | No |
| | | | Greater | |
| 19 | Warning | FRS/Group Policy | Morphed Folders Found | No |
| 20 | Warning | FRS/Group Policy | Orphaned GPTs Found | No |
| 21 | Warning | FRS/Group Policy | Unlinked GPOs Found | No |
| 22 | Warning | Name Resolution | Domain 1C Registrations are not | No |
| | | | consistent | |
| 23 | Warning | Other | Schema Admins Group | No |
| | | | Contains Members | |
| 24 | Informational | Directory service | All Site Links have the same | No |
| | | Replication | cost | |
| 25 | Informational | Directory service | Default LDAP Query Policy | N/A |
| | | Replication | Has Been Customized | |
| 26 | Informational | Master Server Health | DSRM Password | No |
| 27 | Informational | Master Server Health | Managing Event Logs via GPO | No |
| 28 | Informational | Master Server Health | Non-default | Yes |
| | | | userAccountControl values | |
| 29 | Informational | Master Server Health | PAE Enabled on Version 1 of | No |
| | | | operating system master servers | |
| 30 | Informational | Master Server Health | Uptime Exceeds 90 days | No |
| 31 | Informational | Master Server Health | W32Time Event ID 50, Minor | No |
| | | | deviation in time | |
| | | | synchronization | |
| 33 | Informational | FRS/Group Policy | Many ADM files in SYSVOL | No |
| 33 | Informational | FRS/Group Policy | Pre-Existing Files Found | Yes |
| 34 | Informational | Name Resolution | Collapsing Zones | No |
| 35 | Informational | Name Resolution | Generic SRV records | No |
| 36 | Informational | Name Resolution | Single Valid Forwarder | No |
| 37 | Informational | Name Resolution | Unsecured Zone | No |
| 38 | Informational | Name Resolution | WINS Server Consolidation | No |
| 39 | Informational | Name Resolution | Zone Consolidation | No |
| 40 | Informational | Other | 10% Or More Stale Machine | No |
| | | | Accounts | |
| 41 | Informational | Other | 10% Or More Stale User | No |
| | | | Accounts | |
| 42 | Informational | Other | 5% Or More Password Never | No |
| | | | Expires | |
| 43 | Informational | Other | 5% Or More Password Never | No |
| | | | Set | |
| 44 | Informational | Other | Found one or more locked out | No |
| | | | accounts | |
| 45 | Best Practice | Directory Service | Branch Office Environments | N/A |
| | | Replication | | |
| 46 | Best Practice | Master Server Health | Disaster Recovery Discussion | No |
| 47 | Best Practice | Master Server Health | Managing DS, FRS and DNS | No |
| | | | Event Logs via GPO | |
| 48 | Best Practice | Master Server Health | USN Rollback | N/A |
| 49 | Best Practice | Master Server Health | Virtual Master servers | N/A |

Prerequisites

Test Connectivity

One of the key components in determining the overall health of a Directory Service environment is the ability to evaluate every Domain, Site, and master server in the Distributed computing environment. Regardless of the administration model, whether centralized or decentralized, if portions of the environment are unreachable its health and performance cannot be reliably assessed. A connectivity test is run at the beginning of each engagement that attempts to contact every master server in the Distributed computing environment and verify basic network and service availability. The network experienced a wide-spread outage during most of the first date of the engagement. Once this was resolved all of the connectivity tests passed.

Directory Service Replication

Directory Service is a distributed directory service that stores objects representing real-world entities such as users, computers, services, and network resources. Objects in the directory can be distributed to a subset of master servers or all master servers in a distributed computing environment, and all master servers can be updated directly. Directory Service replication is the process by which the changes that originate on one master server are automatically transferred to other master servers that store the same data. Directory Service replication uses a connection topology (aka replication topology) that is by default dynamic and adapts to network conditions and availability of master servers. If problems exist that prevent replication from occurring, information stored in the directory might become outdated. For example, a directory that is not up-to-date is a security risk because a master server might not be aware that an account has been deleted or disabled. Since the scope of Directory Service replication is distributed computing environment-wide, problems preventing replication could very well relate to configuration issues (Configuration data is present on all the master servers in the distributed computing environment irrespective of their domain membership) and thereby originate from a loosely-monitored master server located in a remote location of your Directory Service Infrastructure or due to operational issues. Therefore a well designed and properly functioning replication topology is critical to meeting the stringent performance and availability requirements most companies require due to the critical nature of the services dependent upon it. You will find below key health indicators (findings) concerning your current Directory Service replication health followed by recommendations aimed at improving the overall configuration, architecture and operational efficiency of your distributed computing environment-wide Directory Service replication.

Note: For more information about the various components that ensure successful Directory Service replication, please refer the Technical Reference.

Site Information

The Site Configuration test queries configuration information on the directory service Site topology. This includes information about the bridgehead servers, Site Links, replication connection objects, Site options, LDAP policies, etc.

Error—Single Preferred Bridgehead

The following Site had a single preferred bridgehead defined: BBB

Explanation

Bridgehead servers are master servers that have replication partners in other Sites. The selection of bridgeheads is automatic by default. Manually defining preferred bridgeheads is normally not required since it incurs additional administrative overhead, can reduce the inherent redundancy of directory service and can easily result in replication failures due to invalid configurations. Designating a single bridgehead for a Domain in a Site that contains multiple master servers of that Domain results in a single point of failure since the other master servers will not take over inter-site replication if the preferred bridgeheads goes offline. If done in a major hub location this could cause wide-spread replication failures in the event of a single master server going offline. The single preferred defined for the BBB Site was intentional. That Site contained two master servers, one physical and one virtual. The virtual master server was busy running the E-mail Directory Service Connector and so the directory service staff did not want it to also potentially act as a bridgehead.

Resolution

Since the master server was no longer running the E-mail Directory Service Connector the preferred bridgehead designation was removed. Status: The problem was resolved while onsite.

Warning—Missing Subnets in Directory Service

Master servers are warning of clients authenticating from undefined subnets.

Explanation

Directory Service defines Site boundaries through the subnets associated with them. Proper subnet definitions are the underlying factor that allows clients to locate local master servers. Failure to define subnets will typically result in clients authenticating against random master servers. When clients in undefined subnets authenticate against a master server, the master server will record the client's IP address in %systemroot%\debug\netlogon.log. The master server will also generate Event ID 1 after a short period of time, referencing the netlogon.log file. Version 1 of operating system based master servers will instead generate Event ID 2 that individually lists each client and its IP address. Hundreds of clients were authenticating from undefined subnets. This included the same client authenticating multiple times.

Resolution

Recommend reviewing the netlogon.log files of the master servers and defining all missing subnets. This will prevent clients from authenticating against random master servers.

Status: The problem is not resolved.

Best Practice—Branch Office Environments

The directory service staff should familiarize themselves with the Branch Office Deployment Guide and associated materials.

Explanation

Company A's directory service infrastructure falls under what is termed a “branch office” infrastructure due to the number of remote Sites. The following references contain detailed information regarding design and administrative guidance for such an environment. Any significant changes to the replication topology should be well understood and tested prior to implementation in production.

References:
How Directory Service Replication Topology Works
Branch Offices
Directory Service Branch Office Guide, this is a whitepaper specific to deploying directory service in a branch environment. Chapter 3: Planning the Physical Structure for a Branch Office Deployment is of most relevance with regards to the replication topology.

Informational—Unsecured Zone

The Company A.com zone allowed non-secure dynamic updates.

Explanation

The Diag-DNS test determines if the directory service Domain zones are configured to allow non-secure dynamic updates. Directory service integrated zones can allow non-secure dynamic updates or secure only dynamic updates. Non-secure dynamic updates are normally recommended against since they increase the chances for pollution and hijacking of DNS records. Non-secure dynamic updates are required if systems dynamically register records into the zone but cannot authenticate against directory service.

Resolution

In this case the Company A.com zone apparently included devices that were dynamically registering into it but could not authenticate. If true, then non-secure dynamic updates were required. Status: The problem is not resolved.

What is claimed is:

1. A system for analyzing a directory service, said directory service providing location and administration services for network resources in a distributed computing environment, said system comprising:
a directory service test engine for executing one or more tests to collect data associated with the directory service;
a rules engine for identifying a problem issue of directory service as a function of the collected data; and
a report engine for generating a report representative of the identified problem issue to the directory service.

2. The system of claim 1, wherein the identified problem issue of the directory service includes one or more of the following: an error condition and a best practice enhancement of the directory service.

3. The system of claim 2, wherein the rules engine is configured for assessing a risk associated with each identified error condition; and wherein the generated report includes the assessed risk for each identified error condition.

4. The system of claim 2, wherein the identified error condition of the directory service includes one or more predefined solutions corresponding to each identified error condition; and wherein the generated report includes the predefined solution.

5. The system of claim 2, wherein the identified best practice enhancement of the directory service includes one or more implementation plans corresponding to each identified best practice enhancement; and wherein the generated report includes the implementation plan.

6. The system of claim 1, wherein the rules engine executes a predefined ruleset for determining at least one solution corresponding to the identified problem issue of the directory service, and further comprising a feedback interface for modifying the ruleset when the solution is applied to the directory service.

7. The system of claim 1, further comprising an annotation interface for modifying the determined state of the directory service with expertise specific to the directory service of the distributed computing environment.

8. A method of evaluating a directory service, said directory service providing location and administration services for network resources in a distributed computing environment, comprising:
testing the directory service to collect data associated with a configuration of the directory service;
executing a predefined ruleset against the collected data to identify at least one problem issue with the directory service and a solution corresponding thereto, said identified at least one problem issue and its corresponding solution comprising a result of executing the ruleset against the collected data;
annotating the result with expertise specific to the directory service of the distributed computing environment; and
generating a report representative of the annotated result.

9. The method of claim 8, further comprising defining the ruleset for identifying one or more problem issues associated with the directory service based on the collected data and for specifying one or more solutions corresponding to the identified problem issue.

10. The method of claim 8, further comprising applying the corresponding solution to the directory service to resolve the identified problem issue.

11. The method of claim 8, further comprising:
collecting feedback related to the identified problem issue and its corresponding solution; and
refining the ruleset as a function of the collected feedback.

12. The method of claim 11, wherein the feedback is collected from one or more of the following: an administrator of the directory service, a service engineer, and the execution of one or more tests on the directory service.

13. The method of claim 8, wherein the problem issue is associated with a priority rank and the corresponding solution is applied to the directory service in order of priority rank.

14. The method of claim 8, wherein the directory service includes services related to at least one of the following: Domain Name Service (DNS), directory service replication, connectivity of directory service servers, subnet information, group policy information, internet address information, operating system information of directory service servers, access control list configuration, user accounts, machine accounts, account lockouts.

15. The method of claim 8, further comprising surveying an administrator of the directory service to collect data associated with the configuration of the directory service.

16. One or more computer readable media having computer-executable components for analyzing directory service components within a distributed computing environment, said components comprising:
a directory service testing component for collecting data related to a plurality of directory service components, said testing component comprising:
a directory replication testing component for collecting data related to a directory service replication;
a name resolution testing component for collecting data related to a resolution service;
a master server testing component for collecting data related to a master server, said master server including a database containing information associated with all network users and resources; and
a directory service database testing component for collecting data related to a directory service database;
a ruleset for defining one or more problem issues of the directory service as a function of the collected data;
an analysis engine for executing the ruleset against the collected data to identify at least one problem issue of the directory service; and
a report engine for producing a report identifying the at least one problem issue of directory service.

17. The one or more computer readable media of claim 16, wherein the ruleset includes a priority indicator for each rule of the ruleset.

18. The one or more computer readable media of claim 16, wherein the analysis engine specifies at least one solution to the identified problem issue; and wherein the report includes the solution.

19. The one or more computer readable media of claim 16, further comprising a feedback interface for:
collecting feedback information related to the solution specified by the analysis engine when the solution is applied to the directory service; and
updating the ruleset as a function of the collected feedback information.

20. The one or more computer readable media of claim 16, further comprising an annotation interface for receiving input from an expert familiar with the directory service and modifying the problem issue or the solution, or both, as a function thereof.
